(19) United States
(12) Patent Application Publication
(10) Pub. No.: US 2008/0201863 A1
(43) Pub. Date: Aug. 28, 2008

(54) Knife attachment preventing food sticking to knife surface

(76) Inventor: Xiaoke Yang, Boxborough, MA (US)

Correspondence Address: Xiaoke Yang, 47 Joyce Lane, Boxborough, MA, 01719, US

(21) Appl. No.: 11/716,102

(22) Filed: Mar. 10, 2007

Related U.S. Application Data
(60) Provisional application No. 60/872,603, filed on Dec. 4, 2006.

(51) Int. Cl. B26B 11/00; B23P 19/04

(52) U.S. Cl. 7/158; 29/700

(57) ABSTRACT

A device when attached to a regular kitchen knife that serves as a wedge between the food slice and the knife surface and therefore separating the food slice from the knife surface during a cutting process comprising a stainless steel shell with a curved edge and a convex surface, magnets and rubber stripes fixed together so that this device can be used as an attachment to a knife surface by attraction between the magnets and the ferromagnetic steel knife blade. The rubber stripes provide additional friction between the attachment and the knife surface and prevent sliding of the attachment during cutting. The bubble-like convex surface of the steel shell further prevents food sticking on the surface of the device. The device can be easily attached to and removed from a knife blade.

### CROSS-REFERENCE TO RELATED APPLICATIONS

Provisional application with Application No.: 60/872,603 filed on Dec. 4, 2006.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The invention relates in general to knife for cutting of vegetables, cheese, and boiled eggs and the like. The subject matter of the invention having a curved edge, two magnets and friction enhancing rubber stripes so that the device can be used as an attachment to a regular kitchen knife and serves as a wedge to split food slices from the knife surface and therefore preventing food slice sticking to the knife surface. Food slices sticking to a knife surface is a nuisance during the preparation of vegetables, cheese, boiled eggs and the like. Knife manufacturers therefore have produced knifes that have hollow/granton edges, or non-stick coating surfaces to solve the problem, but without significant effect. Accordingly, there is definitely a need to overcome this nuisance in a more efficient and reliable way.

### BRIEF DESCRIPTION OF THE INVENTION

It is therefore an objective of the present invention to provide a device and methods to prevent food sticking to knife surface during a cutting process. The device herein disclosed is an attachment that when used with a regular knife serves as a wedge between the knife and the food slice and therefore separates the food slice from the knife surface efficiently. The device as an attachment to fulfill the above mentioned function provides major advantages: Attach it only when non-sticking is needed in a cutting job, and when removed it does not hinder knife cleaning and sharpening. Another benefit is that the distance between the curved edge of the device and the edge of the knife is adjustable according to the size of the food object, use longer distance for large food object to reduce friction and shorter distance for small food object to be effective. Furthermore, different knifes can share the same device.

Another objective of the present invention is to provide an efficient method by using a removable device with a regular kitchen knife to prevent food sticking to the knife, instead of building certain features into the knife itself, such as previously mentioned hollow/granton edges and non-sticking coatings.

A further objective of the present invention is to provide a convenient means to fulfill the attachment and remove of a device from a ferromagnetic surface by using magnetic interactions.

Yet another objective of the present invention is to provide methods to attach a strong magnetic device to and remove it from a ferromagnetic surface easily and safely.

### BRIEF DESCRIPTION OF THE SEVERAL VIEWS OF THE DRAWINGS

FIG. 1 is a perspective view of the device from the top.

FIG. 2 is a perspective view of the device from the bottom.

FIG. 3 is the cross sectional view of the device from the top

FIG. 4 is the cross sectional view of the device from the bottom.

FIG. 5 is the cross sectional view of the device from the side.

FIG. 6 is a perspective view of the device on a knife blade in its closed position.

FIG. 7 is a perspective view of the device on a knife blade in its open position.

FIG. 8 is the cross sectional view of the device on a knife blade in its open position as the first step being attached to a knife surface.

FIG. 9 is the cross sectional view of the device on a knife blade in its closed position as the second step being attached to a knife surface.

FIG. 10 is the cross sectional view of the device on a knife blade in its close position as being pushed into its open position.

FIG. 11 is the cross sectional view of the device on a knife blade in its open position as being removed from the knife surface.

### DETAILED DESCRIPTION OF THE INVENTION

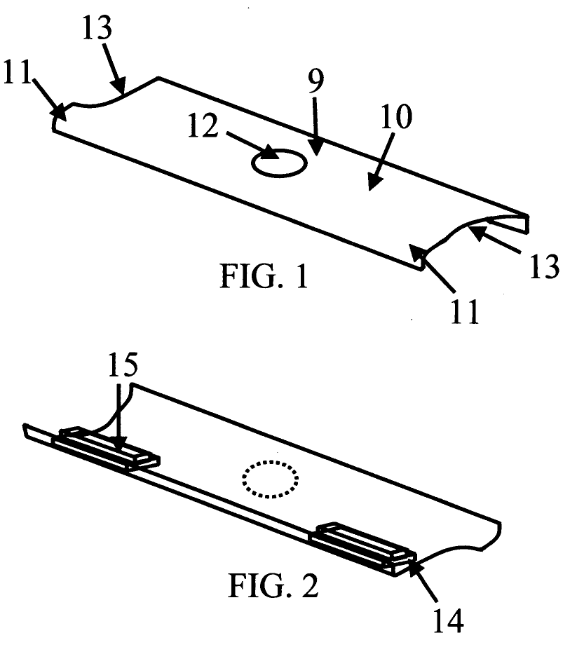

Referring to the drawings, FIG. 1 and FIG. 2 show device 9 as an attachment to a knife for preventing food slice sticking to the knife surface during a cutting process. The device 9 comprises a stainless steel shell 10, which has a curved edge 11, a bubble-like convex surface 12 on the top and two concaved finger holds 13 at each end, two magnets 14 and two rubber stripes 15. The magnets 14 are glued to the stainless steel shell 10 and the rubber stripes 15 are fixed to the magnets 14 as shown in the FIGS.

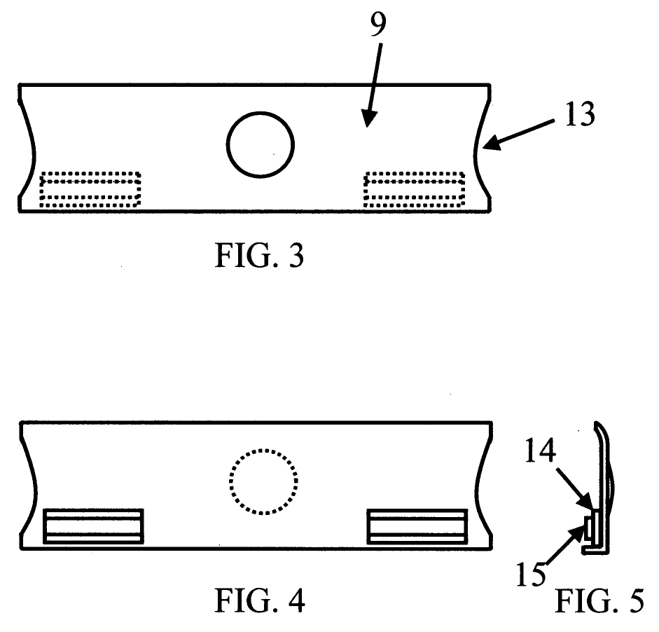

FIGS. 3, 4 and 5 show the cross sectional views of device 9 from the top, the bottom and the side, respectively. The concaved finger holds 13, the magnets 14 and the rubber stripes 15 are indicated.

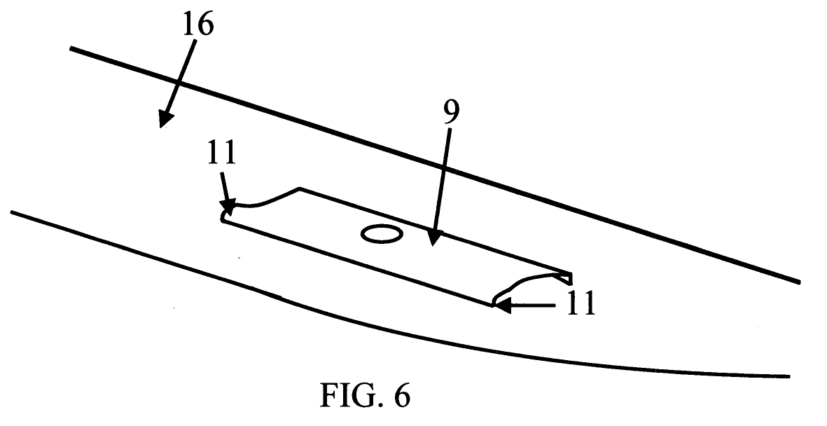

As shown in FIG. 6, device 9 is attached to a knife blade in its working (close) position. In this position, the curved edge 11 of device 9 is seamlessly attached to the knife surface 16 about half an inch from the edge of the knife. During a cutting process, the food slice that is being cut off will be pushed away from the surface of the knife without increasing friction.

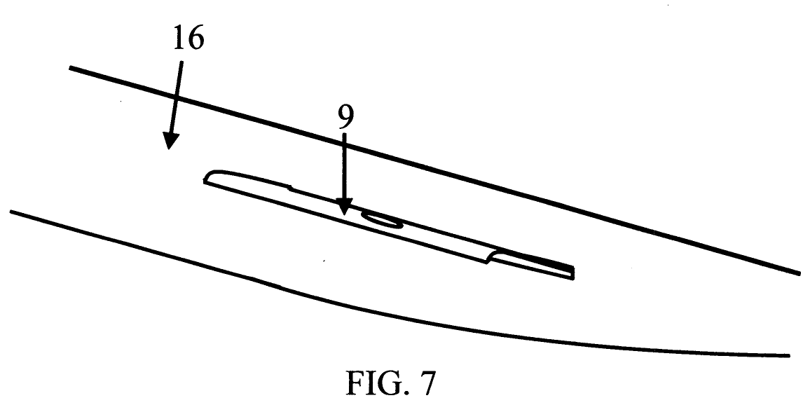

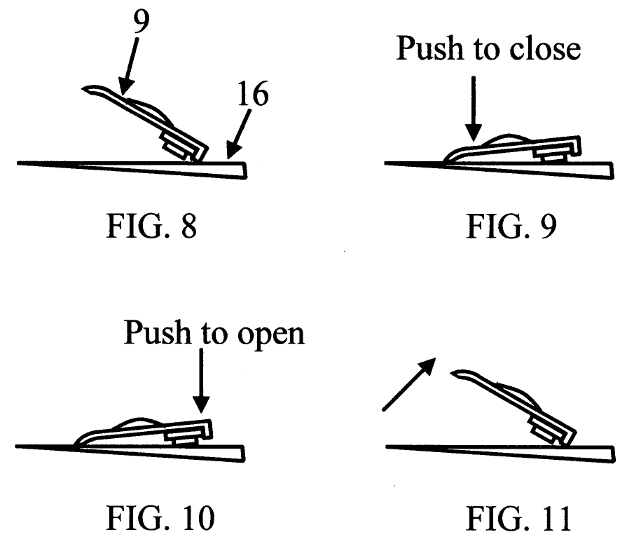

FIG. 7 shows device 9 is attached to a knife blade 16 in its open position. This position is a transient position when device 9 is being attached to or removed from knife blade 16. Since attaching a strong magnet to a ferromagnetic surface could be dangerous due to strong attraction, the process involves two steps: First, bring device 9 to knife surface 16 in a perpendicular position and allow device 9 to touch knife blade 16 and then let it go. Device 9 will be locked into this open position by weak attraction (only the edges of the magnets are effective) as shown in FIG. 8. Then slowly rotate device 9 towards the knife surface and it will be locked by strong attraction (faces of the magnets are effective) into the close position as shown in FIG. 9. When device 9 needs to be removed from knife blade 16, it also involves two steps: First, push the rear part of device 9 as shown by the arrow in FIG. 10 and it will be locked into the open positions as shown in FIG. 11. Then hold both ends of device 9 by the finger holds 13 and rotate it away from the knife blade 16 as indicated by the arrow in FIG. 11 and then remove it from the blade. Device 9 cannot be removed from the knife blade 16 by simply pulling it or sliding it away from the knife blade 16 due to strong magnetic interaction.

When device 9 is attached to regular knife blade 16, the knife can be used the same way, as there was no attachment. Device 9 will stay in the locked working position as it was initially attached. The distance between the curved edge 11 of the device and the edge of the knife is determined by the cutting job. A large cutting object requires a longer distance to reduce friction and a small object needs a shorter distance to be effective. Usually half an inch is a good estimation for most cutting jobs.

What is claimed is:

1. A device used as an attachment to a regular knife to prevent sticking of food slices to the knife surface.
Said attachment means an independent device that can be fixed to and removed from the knife blade other than certain features built into the knife itself that cannot be removed and reattached.

2. A device used as an attachment with a regular knife to prevent sticking of food slice to the knife surface according to claim 1 comprising: a stainless steel shell with a convexly curved edge and two concaved finger holds at each end; two magnets that are fixed to said stainless steel shell; each said magnet has a rubber stripe fixed onto its surface to provide additional friction between said device and the knife surface; the said magnets, said rubber stripes, and said stainless steel shell are arranged in certain positions relative to each other so that the combined device can be attached to a knife surface conveniently and safely, and can also be remove from a knife surface conveniently and safely.

3. A device as an attachment to a knife blade according to claim 1 by using magnetic attraction.

4. A device as an attachment to a knife blade according to claim 1 by using friction-enhancing materials, such as rubber between the magnets and the ferromagnetic knife surface to lock the said device into a desired position.

5. Methods for attaching a strong magnetic device to and removing from a ferromagnetic surface conveniently and safely.
